(19) United States
(12) Patent Application Publication
(10) Pub. No.: US 2026/0331989 A1
(43) Pub. Date: Oct. 22, 2026

(54) VERTICAL SPLIT BOBBIN FOR ELECTRIC MOTOR STATOR

(71) Applicant: Schaeffler Technologies AG & Co. KG, Herzogenaurach (DE)

(72) Inventors: Lukas FLOCKEN, Wadsworth, OH (US); Brian FOUST, Lakewood, OH (US); Jeremy VANNI, Medina, OH (US)

(73) Assignee: Schaeffler Technologies AG & Co. KG, Herzogenaurach (DE)

(21) Appl. No.: 19/181,466

(22) Filed: Apr. 17, 2025

(51) Int. Cl. H02K 3/52; H02K 1/14

(52) U.S. Cl. CPC H02K 3/52; H02K 1/146; H02K 2203/12

(57) ABSTRACT

An electric motor having a stator with stator teeth. Bobbins are located on the stator teeth, and the stator coil wires are wound thereon. Each bobbin includes first and second bobbin halves. The first bobbin half includes a first top and first bottom, and a first side connected to and extending therebetween which is located on the first side of the stator tooth. The second bobbin half includes a second top and second bottom, and a second side connected to and extending therebetween located on the second side of the stator tooth. The first and second tops are connected to form a bobbin top at a first axial end, and the first and second bottoms are connected to form a bobbin bottom at a second axial end. A thickness of each of the sides is less than a thickness of either of the top or bottom.

### TECHNICAL FIELD

The disclosure relates to electric motors, and particularly to the stator of an electric motor. More particularly, the disclosure relates to bobbin(s) that are installed on stator teeth of the stator core onto which the stator coil(s) are wound.

### BACKGROUND

The stator of an electric motor includes a core that can be composed of steel plates/laminations. Stator coils wind around stator teeth formed by grooves in the stator core. All motors have some type of insulation between the stator teeth and the stator coils. A common construction of motors involves winding stator coils onto bobbins formed of an insulating material that are installed on the stator teeth. These bobbins insulate the stator coil wires from the steel plates of the stator core.

The bobbins are generally made of an electrically insulating polymeric material and can be molded in one or more pieces. Some known electric motor bobbins are split in half horizontally for ease of installation on the stator teeth. This causes the plastic bobbin wall that runs along the active length of the stator to be thicker in order to connect the pieces which affects motor performance.

It would be desirable to provide a multi-part bobbin that is easy to manufacture and does not take up too much space in the active length of the stator teeth in order to improve motor performance.

In one aspect, an electric motor is provided that includes a rotor and a stator, with the rotor being mounted for rotation relative to the stator. The stator includes a stator core, which can be formed from a plurality of laminated steel plates assembled in a plate stack, with the core having a plurality of stator teeth that each include first and second sides that extend in an axial direction between first and second axial ends of the stator teeth. A plurality of stator coil wires are assembled on the stator teeth. A respective bobbin is located on each of the stator teeth, and the stator coil wires are wound on the bobbins. Each bobbin includes a first bobbin half and a second bobbin half. The first bobbin half includes a first top and a first bottom that are adapted to be arranged at the respective first and second axial ends of a respective one of the stator teeth, and a first side connected to and extending between the first top and the first bottom and which is adapted to be located on the first side of the respective stator tooth. The second bobbin half includes a second top and a second bottom that are adapted to be arranged at the respective first and second axial ends of the respective stator tooth, and a second side connected to and extending between the second top and the second bottom and which is adapted to be located on the second side of the respective stator tooth. With the first and second bobbin halves being located about the respective one of the stator teeth, the first top is connected to the second top to form a bobbin top, and the first bottom is connected to the second bottom to form a bobbin bottom, with the first and second sides of the first and second bobbin halves being located on the respective first and second sides of the stator tooth. A thickness of each of the first and second sides is less than a thickness of either of the bobbin top or the bobbin bottom. With this arrangement, the thin sides of the bobbin are located along the active length of the stator teeth, which helps improve performance of the motor. In the prior known two-piece bobbins with the horizontal split, this was not the case as the connections between the prior bobbin parts were in the area of the sides of the stator teeth and not the axial ends.

In one embodiment, the first top includes a top connector and the second top includes a top mating connector, and the first bottom includes a bottom connector and the second bottom includes a bottom mating connector, and the top connector and the top mating connector engage one another with at least one of an interference or snap connection, and the bottom connector and the bottom mating connector engage one another with at least one of an interference or snap connection. The positions of one or both of the top connector and top mating connector or the bottom connector and the bottom mating connector can be switched

In one embodiment, the top and bottom connectors each include a respective male interlocking feature, and the top and bottom mating connectors each include a respective female interlocking feature that receives the respective male interlocking feature.

In a particular embodiment, the respective male interlocking features each comprise a distal tab and a stem that connects the tab to the respective first top or first bottom, and the respective female interlocking features each include a complementary recess to the respective distal tab.

In one embodiment, each said bobbin further includes a top protection flap that extends from the second top to a position between the first top and the first axial end of the respective stator tooth, and a bottom protection flap that extends from the second bottom to a position between the first bottom and the second axial end of the respective stator tooth. These protection flaps overlap the seam between ends at the top and bottom of the first and second bobbin halves at the respective male and female interlocking features in order to protect from electrical creepage through the gap between the first and second bobbin halves in order to avoid the possibility of electrical grounding from a stator coil to the stator core. The protection flaps could extend from the first half or one of the protection flaps could extend from each half.

In one embodiment, the first bobbin half is an integrally molded polymeric (or plastic) part, and the second bobbin half is a second integrally molded polymeric (or plastic) part.

In one embodiment, each bobbin includes first and second axial ends, and flanges extend radially from the first and second sides at each of the first and second axial ends. These flanges may provide further insulation at the base of the gaps between the stator teeth and at a position at the ends of the stator teeth.

In another aspect, a bobbin is provided for installation on a stator tooth of an electric motor onto which a stator coil is adapted to be wound, the bobbin includes a first bobbin half and a second bobbin half. The first bobbin half includes a first top and a first bottom that are adapted to be arranged at respective first and second axial ends of the stator tooth, and a first side connected to and extending between the first top and the first bottom and being adapted to be located on a first side of the stator tooth. The second bobbin half includes a second top and a second bottom that are adapted to be arranged at the respective first and second axial ends of the stator tooth, and a second side connected to and extending between the second top and the second bottom and being adapted to be located on a second side of the stator tooth. The first top is connected to the second top to form a bobbin top, and the first bottom is connected to the second bottom to form a bobbin bottom. A thickness of each of the first and second sides of the respective first and second bobbin halves is less than a thickness of either of the bobbin top or the bobbin bottom.

In one aspect, the first top includes a top connector and the second top includes a top mating connector, and the first bottom includes a bottom connector and the second bottom includes a bottom mating connector, and the top connector and the top mating connector engage one another with at least one of an interference or snap connection, and the bottom connector and the bottom mating connector engage one another with at least one of an interference or snap connection. The positions of one or both of the top connector and top mating connector or the bottom connector and the bottom mating connector can be switched.

In one embodiment, the top and bottom connectors each include a respective male interlocking feature, and the top and bottom mating connectors each include a respective female interlocking feature that receives the respective male interlocking feature.

On one specific embodiment, the respective male interlocking features each comprise a distal tab and a reduced neck that connects the tab to the respective first top or first bottom, and the respective female interlocking features each include a complementary recess to the respective distal tab.

In one embodiment, each said bobbin further includes a top protection flap that extends from the second top to a position under the first top toward an interior of the bobbin, and a bottom protection flap that extends from the second bottom to a position under the first bottom toward the interior of the bobbin. These protection flaps overlap the seam between ends at the top and bottom of the first and second bobbin halves at the respective male and female interlocking features in order to protect from electrical creepage through a gap between the first and second bobbin halves. This is done in order to avoid the possibility of electrical grounding from a stator coil to the stator core via such gap. The protection flaps could extend from the first half or one of the protection flaps could extend from each half.

In one embodiment, the first bobbin half is an integrally molded polymeric (or plastic) part, and the second bobbin half is a second integrally molded polymeric (or plastic) part.

In one embodiment, the bobbin includes first and second axial ends, and flanges extend radially from the first and second sides at each of the first and second axial ends.

One or more of the above features can be combined to provide a stator as well as an electric motor having such a stator with improved reliability and performance.

### BRIEF DESCRIPTION OF THE DRAWINGS

The foregoing Summary as well as the following Detailed Description will be best understood when read in conjunction with the appended drawings, which illustrate an embodiment according to the disclosure. In the drawings:

FIG. 1 is a schematic cross-sectional view through an electric motor in accordance with the present disclosure.

FIG. 2 is a half cross-sectional view of the stator portion of the electric motor taken along line 2-2 in FIG. 1 showing a portion of the stator of the electric motor in FIG. 1 having bobbins located on the stator teeth and showing stator coil wires wound at least on some of the stator teeth around the bobbins.

FIG. 3 is a perspective view of a bobbin in accordance with an embodiment of the present disclosure that is assembled from two bobbin halves.

FIG. 4 is an end view of the bobbin shown in FIG. 3.

FIG. 5 is an end view showing one bobbin half of the bobbin shown in FIGS. 3 and 4.

FIG. 6 is an end view showing the other bobbin half for the bobbin shown in FIGS. 3 and 4.

FIG. 7 is a bottom view of the bobbin shown in FIGS. 3-6.

FIG. 8 is a bottom view of one of the bobbin halves shown in FIG. 7.

FIG. 9 is a bottom view of the other bobbin half shown in FIG. 7.

FIG. 10 is a partial cross-sectional view of the bobbin taken along line 10-10 in FIG. 7.

### DETAILED DESCRIPTION

Certain terminology is used in the following description for convenience only and is not limiting. “Axial” refers to a direction along an axis. A reference to a list of items that are cited as “at least one of a, b, or c” (where a, b, and c represent the items being listed) means any single one of the items a, b, or c, or combinations thereof. The terms “generally”, “about” and “approximately” are to be construed as within 10 % of a stated value or ratio, or are as otherwise noted herein with respect to a geometric shape. The term “half” as used on connection with the first and second bobbin halves is not intended to infer an equal division between the first and second bobbin halves, and one part could have a larger size than the other. The terminology includes the words specifically noted above, derivatives thereof, and words of similar import.

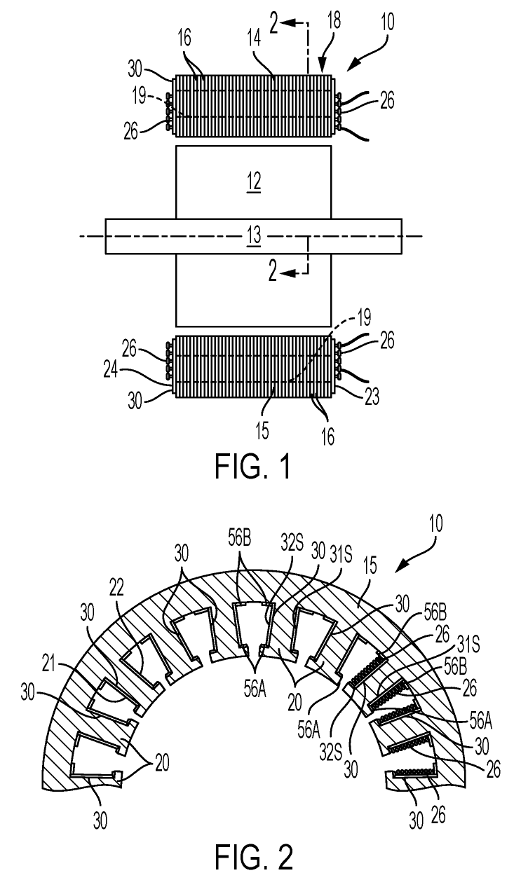

FIG. 1 shows a cross-sectional view of an electric motor 10 in accordance with the present disclosure. The electric motor 10 includes a rotor 12 which is mounted on a shaft 13 as well as a stator 14, with the rotor 12 being mounted for rotation relative to the stator 14. The stator includes a core 15, which is shown as including a plurality of laminated steel plates 16 that are assembled in a plate stack 18, and include grooves 19 to form a plurality of radially inwardly directed stator teeth 20 that each include first and second axial sides 21, 22 (indicated in FIG. 2) that extend in an axial direction between the first and the second axial ends 23, 24 of the stator teeth 20. As can be seen in FIGS. 1 and 2, a plurality of stator coil wires 26 are assembled on the stator teeth 20.

As shown in FIG. 2, in order to insulate the stator teeth 20 electrically from the stator coil wires 26, bobbins 30 made of an electrical insulating polymeric or plastic material are located on each of the respective stator teeth 20. The stator coil wires 26 are then wound on the bobbins 30 in order to form the stator 14. FIG. 2 shows stator coil wires 26 wound on a few of the stator teeth 20. However, as will be recognized those skilled in the art based on the present disclosure, the stator wires 26 are wound over the bobbins 30 on each of the stator teeth 20 in order to form the finished stator 14.

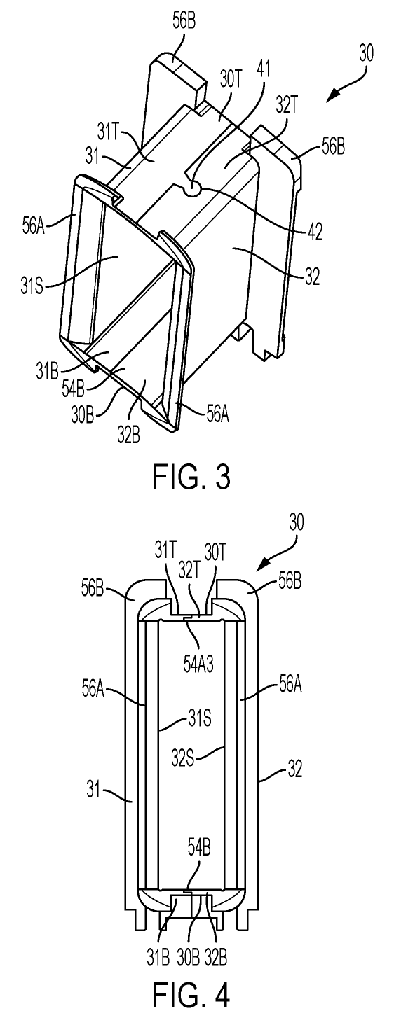

Referring now to FIGS. 3-10, one embodiment of a bobbin 30 is shown in detail along with its component parts.

As shown in FIGS. 3, 4, 6, 7, and 9, the bobbin 30 includes a first bobbin half 31 and, as shown in FIGS. 3, 4, 5, 7, and 8, a second bobbin half 32. The first bobbin half 31 includes a first top 31T and a first bottom 31B that are adapted to be arranged at the respective first and second axial ends 23, 24 of a respective stator one of the teeth 20. A first side 31S is connected and extends between the first top 31T and the first bottom 31B and is adapted to be located on the first side 21 of the respective stator tooth 20. The second bobbin half 32 includes a second top 32T and a second bottom 32B that are adapted to be arranged at the respective first and second axial ends 23, 24 of the respective stator tooth 20. A second side 32S is connected to and extends between the second top 32T and the second bottom 32B and is adapted to be located on the second side 22 of the respective stator tooth 20.

Referring to FIGS. 3 and 7, with the first and second bobbin halves 31, 32 being located about the respective one of the stator teeth 20, the first top 31T is connected to the second top 32T to form a bobbin top 30T, and the first bottom 31B is connected to the second bottom 32B to form a bobbin bottom 30B. Here, the respective first and second sides 31S, 32S of the first and second bobbin halves 31, 32 are located adjacent to the respective first and second sides 21, 22 of the stator tooth 20, and the bobbin is held on the stator tooth 20 by a form fit connection, for example as shown in FIG. 2 As shown in FIG. 10, a thickness Tₛ of each of the first and second sides 31S, 32S is less than a thickness T of either of the bobbin top 30T or the bobbin bottom 30B.

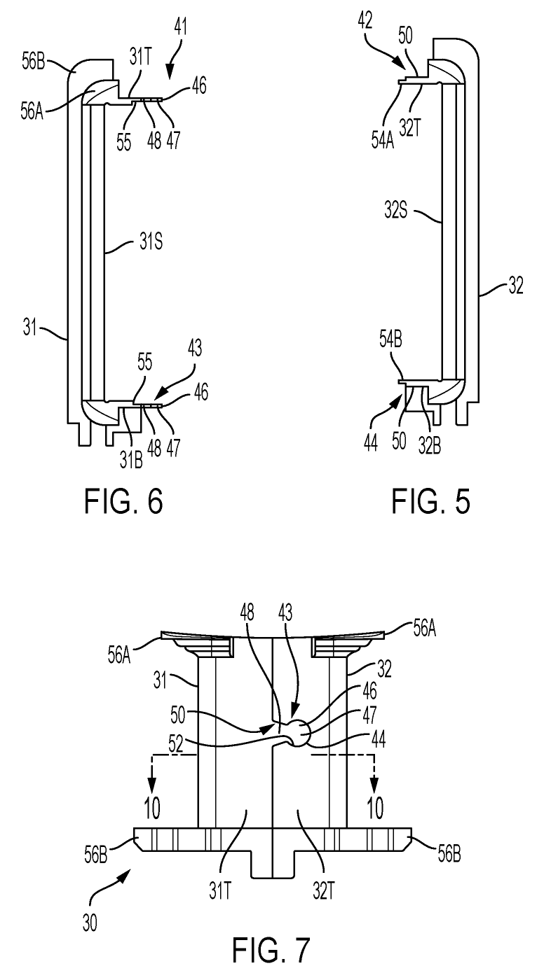

As can be seen most clearly in FIGS. 5-9, the first top 31T includes a top connector 41 and the second top 32T includes a top mating connector 42. The first bottom 31B includes a bottom connector 43 and the second bottom 32B includes a bottom mating connector 44. The top connector 41 and the mating top connector 42 engage one another with at least one of an interference or snap connection, and the bottom connector 43 and the bottom mating connector 44 also engage one another with at least one of an interference fit or snap connection for installation on the stator tooth 20 (or if the bobbin 30 is assembled even without being applied on the stator 14). In the illustrated embodiment, the top connector 41 and the bottom connector 43 have the same configuration, and the top mating connector 42 and the bottom mating connector 44 have the same configuration. However, the configurations could be different as long as the top connector 41 and the top mating connector 42 are complementary, and the bottom connector 43 and the bottom mating connector 44 are complementary.

In the illustrated embodiment, the top and bottom connectors 41, 43 each include a respective male interlocking feature 46, and the top and bottom mating connectors 42, 44 each include a respective female interlocking feature 50 that receives the respective male interlocking feature 46. Specifically, as can be seen in detail from FIGS. 5, 6, 8, and 9, the respective male interlocking features 46 each include a distal tab 47 and a stem 48 that connects the distal tab 47 to the respective first top 31T or the first bottom 31B such that they extend outwardly away from an end of the first top 31T and first bottom 31B to a position where they can engage with the respective female interlocking feature 50 of the top and bottom mating connectors 42, 44. The respective female interlocking features 50 each include a complementary recess 52 to the respective distal tab 47, and in the illustrated embodiment, also the stem 48.

The first bobbin half 31 is preferably formed as an integrally molded polymeric (or plastic) part, and the second bobbin half 32 is also formed of as a second integrally molded polymeric (or plastic) part. Both of these parts 31, 32 are electrically insulating and include some resiliency in order to allow the snap connections shown to inter-engage one another as the bobbin 30 is assembled from respective first and second bobbin halves 31, 32 when they are placed around a stator tooth 20 for assembly.

With this arrangement, the thin sides 31S, 32S of the bobbin 30 are located along the active length of the stator teeth 20 which helps improve performance of the motor 10 in comparison to the prior known two-piece bobbins which included a horizontal split and a corresponding increase in thickness in these areas.

In order to provide further safety and avoid potential electrical grounding between the stator coil wires 26 and the stator core 15, as can be seen in FIGS. 4 and 5, the bobbin 30 further includes a protection flap 54T that extends from the second top 32T to a position between the first top 31T and the first axial end 23 of the respective stator tooth 20 in the installed position, or beneath the first top 31T if the bobbin 30 is assembled separately as shown for the purposes of illustration in FIGS. 3, 4, 7, and 10. Further, a bottom protection flap 54B is provided that extends from the second bottom 32B to a position between the first bottom 31B and the second axial end 24 of the respective stator tooth 20 in the installed position, or inwardly of the first bottom 31B if the bobbin 30 is assembled separately as shown for the purposes of illustration in FIGS. 3, 4, 7, and 10. These protection flaps 54T, 54B overlap the seam between the ends of the top and bottom 31T, 32T; 31B, 32B of the first and second bobbin halves 31, 32 at the respective male and female interlocking features 46, 50 in order to protect from electrical creepage through the gap between the first and second bobbin halves 31, 32 that could form a grounding path to the stator core 15. By having this overlapping top protection flap 54T and bottom protection flap 54B, even if there is some creepage the overlap extends over any potential grounding path.

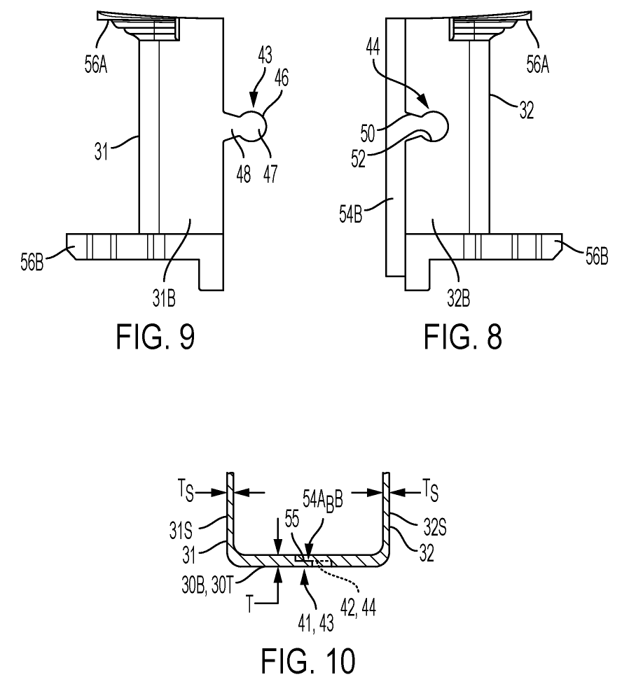

As shown in FIGS. 5 and 8, the top protection flap 54T and bottom protection flap 54B may extend under the complementary recess 52 of the female interlocking feature. Further, as shown in FIGS. 5 and 6, the first top 31T and the first bottom 31B can include a recess 55 into which the top protection flap 54T and bottom protection flap 54B are received so that the bobbin top 30T and the bobbin bottom 30T formed upon assembly of the first and second bobbin halves 31, 32 have a uniform thickness.

Still with reference to FIGS. 3-9, each bobbin 30 may include flanges 56A, 56B that extend radially from the first and second sides 31S, 32S at each of the first and second axial ends 36, 38 of the bobbin 30. These flanges provide an insulated wrapping space for the stator coil wires 26. The specific shape of the flanges 56A, 56B can vary depending on the particular application and are designed to prevent potential grounding paths between the stator coil wires 26 and the stator core 15.

The bobbin 30 as shown in FIGS. 3-9 can also be supplied separately for installation on a stator 14 of an electric motor 10 on to which a stator coil 26 is adapted to be wound. The bobbin 30 includes the first bobbin half 31 and the second bobbin half 32 as described above wherein the first top 31T is adapted to be connected to the second top 32T to form the bobbin top 30T and the first bottom 31B is adapted to be connected to the second bottom 32B to form the bobbin bottom 30B. Here, the thickness T_{S} of each of the first and second sides 31S, 32S is less than a thickness T of either the bobbin top 30T or bobbin bottom 30B.

The bobbin 30 can be formed with the top and bottom connectors 41, 43 on the same bobbin half 31 or 32, or they may be formed on opposite bobbin halves 31, 32. Accordingly, the top mating connector 42 and the bottom mating connector 44 can also be formed on either one of the first or second bobbin halves 31, 32 or on opposite ones of the first and second bobbin halves 31, 32 in complementary positions to the top and bottom connectors 41, 43. All that is specifically required in that the top and bottom connectors 41, 43 and the top and bottom mating connectors 42, 44 are arranged such that the first and second bobbin halves 31, 32 can be connected together to form the bobbin 30.

Further, while FIGS. 3 and 7-9 illustrate one specific configuration for the male interlocking feature 46 and the female interlocking feature 50 which include the male interlocking feature 46 having a distal tab 47 and a stem 48 and the female interlocking feature including a complementary recess 52, different shapes could also be provided in order to provide such a locking connection via an interference or snap connection.

Further, the configuration of the flanges 56A, 56B can be varied depending on the particular application.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 electric motor

12 rotor

13 shaft

14 stator

15 stator core

16 steel plates

18 plate stack

19 grooves

20 stator teeth

21 first axial side

22 second axial side

23 first axial end

24 second axial end

26 stator coil wires

30 bobbin

30T bobbin top

30H bobbin bottom

31 first bobbin half

31T first top

31B first bottom

31S first side

32T second top

32B second bottom

32S second side

41 top connector

42 top mating connector

43 bottom connector

44 bottom mating connector

46 male interlocking feature

47 distal tab

48 stem

50 female interlocking feature

52 complementary recess

54T, 54B protection flaps

56A, 56B flanges

T thickness of bobbin top or bottom

TS thickness of bobbin side(s)

1. An electric motor, comprising:
a rotor;
a stator, the rotor being mounted for rotation relative to the stator, the stator including a core having a plurality of stator teeth that each include first and second sides that extend in an axial direction between first and second axial ends of the stator teeth, and a plurality of stator coil wires assembled on the stator teeth;
a respective bobbin located on each of the stator teeth, and the stator coil wires being wound on the bobbins, each said bobbin including:
a first bobbin half and a second bobbin half, the first bobbin half including a first top and a first bottom that are adapted to be arranged at the respective first and second axial ends of a respective one of the stator teeth, and a first side connected to and extending between the first top and the first bottom and which is adapted to be located on the first side of the respective stator tooth, the second bobbin half including a second top and a second bottom that are adapted to be arranged at the respective first and second axial ends of the respective stator tooth, and a second side connected to and extending between the second top and the second bottom and which is adapted to be located on the second side of the respective stator tooth, with the first and second bobbin halves being located about the respective one of the stator teeth, the first top is connected to the second top to form a bobbin top, and the first bottom is connected to the second bottom to form a bobbin bottom, with the respective first and second sides of the first and second bobbin halves being located adjacent to the respective first and second sides of the stator tooth, and wherein a thickness of each of the first and second sides is less than a thickness of either of the bobbin top or the bobbin bottom.

2. The electric motor of claim 1, wherein the first top includes a top connector and the second top includes a top mating connector, and the first bottom includes a bottom connector and the second bottom includes a bottom mating connector, and the top connector and the top mating connector engage one another with at least one of an interference or snap connection, and the bottom connector and the bottom mating connector engage one another with at least one of an interference or snap connection.

3. The electric motor of claim 2, wherein the top and bottom connectors each include a respective male interlocking feature, and the top and bottom mating connectors each include a respective female interlocking feature that receives the respective male interlocking feature.

4. The electric motor of claim 3, wherein the respective male interlocking features each comprise a distal tab and a stem that connects the distal tab to the respective first top or first bottom, and the respective female interlocking features each include a complementary recess to the respective distal tab.

5. The electric motor of claim 2, wherein each said bobbin further includes a top protection flap that extends from the second top to a position between the first top and the first axial end of the respective stator tooth, and a bottom protection flap that extends from the second bottom to a position between the first bottom and the second axial end of the respective stator tooth.

6. The electric motor of claim 1, wherein the first bobbin half is an integrally molded polymeric part, and the second bobbin half is a second integrally molded polymeric part.

7. The electric motor of claim 1, wherein each said bobbin includes first and second axial ends, and flanges extend radially from the first and second sides at each of the first and second axial ends.

8. A bobbin adapted for installation on a stator tooth of an electric motor onto which a stator coil is adapted to be wound, the bobbin comprising:
a first bobbin half and a second bobbin half, the first bobbin half including a first top and a first bottom that are adapted to be arranged at respective first and second axial ends of the stator tooth, and a first side connected to and extending between the first top and the first bottom and being adapted to be located on a first side of the stator tooth, the second bobbin half including a second top and a second bottom that are adapted to be arranged at the respective first and second axial ends of the stator tooth, and a second side connected to and extending between the second top and the second bottom and being adapted to be located on a second side of the stator tooth, the first top is connected to the second top to form a bobbin top, and the first bottom is connected to the second bottom to form a bobbin bottom, and wherein a thickness of each of the first and second sides is less than a thickness of either of the bobbin top or the bobbin bottom.

9. The bobbin of claim 8, wherein the first top includes a top connector and the second top includes a top mating connector, and the first bottom includes a bottom connector and the second bottom includes a bottom mating connector, and the top connector and the top mating connector engage one another with at least one of an interference or snap connection, and the bottom connector and the bottom mating connector engage one another with at least one of an interference or snap connection.

10. The bobbin of claim 9, wherein the top and bottom connectors each include a respective male interlocking feature, and the top and bottom mating connectors each include a respective female interlocking feature that receives the respective male interlocking feature.

11. The bobbin of claim 10, wherein the respective male interlocking features each comprise a distal tab and a reduced neck that connects the tab to the respective first top or first bottom, and the respective female interlocking features each include a complementary recess to the respective distal tab.

12. The bobbin of claim 9, wherein each said bobbin further includes a top protection flap that extends from the second top to a position under the first top toward an interior of the bobbin, and a bottom protection flap that extends from the second bottom to a position under the first bottom toward the interior of the bobbin.

13. The bobbin of claim 8, wherein the first bobbin half is an integrally molded polymeric part, and the second bobbin half is a second integrally molded polymeric part.

14. The bobbin of claim 8, wherein the bobbin includes first and second axial ends, and flanges extend radially from the first and second sides at each of the first and second axial ends.
